(19) United States
(12) Patent Application Publication
(10) Pub. No.: US 2021/0166307 A1
(43) Pub. Date: Jun. 3, 2021

(54) RISK ASSESSMENT COMMUNICATION SYSTEM

(71) Applicant: Wells Fargo Bank, N.A., San Francisco, CA (US)

(72) Inventors: Leah Jean Goldberg, Denver, CO (US); Armand J. Brunelle, III, San Francisco, CA (US); Robert Peacock, Denver, CO (US); Nicole Ross, San Francisco, CA (US); James J. Russell, Castle Pines, CO (US); Jeffrey R. Woodbury, Maple Grove, MN (US)

(21) Appl. No.: 15/730,586

(22) Filed: Oct. 11, 2017

(51) Int. Cl. G06Q 40/02; G06Q 30/06

(52) U.S. Cl. CPC G06Q 40/025; G06Q 30/06

(57) ABSTRACT

This disclosure describes techniques that include collecting information used in determining the value of assets and/or collateral, and automation of certain aspects of processing of requests to advance funds from a line of credit. In one example, this disclosure describes a method that maintaining, for each of a plurality of entities, access credentials; receiving, over a network, an advance request; identifying, based on the advance request, a requesting entity associated with the advance request and an advance amount associated with the advance request, wherein the requesting entity is one of the plurality of entities; accessing, over the network using the access credentials for the requesting entity, financial information maintained by the requesting entity, wherein the financial information includes accounts receivable information associated with the requesting entity and aging information associated with the accounts receivable information; and determining, based on the financial information, a borrowing base for the requesting entity.

### TECHNICAL FIELD

Aspects of this disclosure relate to computer networks, and more specifically, to communicating, over a network, financial information.

### BACKGROUND

Supply chain finance involves business and financing processes that link participants in a supply chain in a manner that enables one or more of such participants to improve working capital efficiency. In some scenarios, a supply chain involves a reseller (sometimes referred to as a “buyer”) that purchases products from a vendor (sometimes referred to as a “product vendor,” “manufacturer,” or “supplier”). The reseller then resells the purchased products to end users. In some cases, the reseller may couple the resale of the products with a service. For instance, if the vendor is a manufacturer of complex computer networking products, the reseller may purchase those products from the vendor and then not only resell those networking products to end users, but also provide services to those end users relating to the installation of the networking products. A lender, bank, or other financial institution can play a role in a supply chain by providing short-term credit to one or more participants in the supply chain.

### SUMMARY

This disclosure describes techniques that include collecting information used in determining the value of assets and/or collateral, and automation or near-automation of certain aspects of processing of requests to advance funds from a line of credit or other financial arrangement. Techniques in accordance with one or more aspects of the present disclosure may enable more accurate assessment of asset and collateral value, and may enable faster and more efficient and processing of financial transactions. As described in one or more examples, techniques described herein may involve receiving, by a computing system and from a computing device controlled by a borrower, a request to advance funds from a line of credit. In some examples, the computing system may access, over a network, financial information maintained by a borrower, including information about accounts receivables and aging information relating to such accounts receivables. Techniques described herein may further involve determining, based on the financial information maintained by the borrower, an updated borrowing base and/or available credit amount for the borrower.

In one example, this disclosure describes a method comprising maintaining, by a computing system and for each of a plurality of entities, access credentials; receiving, by the computing system and over a network, an advance request; identifying, by the computing system and based on the advance request, a requesting entity associated with the advance request and an advance amount associated with the advance request, wherein the requesting entity is one of the plurality of entities; accessing, by the computing system and over the network using the access credentials for the requesting entity, financial information maintained by the requesting entity, wherein the financial information includes accounts receivable information associated with the requesting entity and aging information associated with the accounts receivable information; determining, by the computing system and based on the financial information, a borrowing base for the requesting entity; determining, by the computing system and based on the borrowing base and the advance amount, a status for the advance request; and sending, by the computing system and over the network, information about the status for the advance request.

In another example, this disclosure describes a system comprising a storage device; and processing circuitry having access to the storage device and configured to: maintain, for each of a plurality of entities, access credentials, receive, over a network, an advance request, identify, based on the advance request, a requesting entity associated with the advance request and an advance amount associated with the advance request, wherein the requesting entity is one of the plurality of entities, access, over the network using the access credentials for the requesting entity, financial information maintained by the requesting entity, wherein the financial information includes accounts receivable information associated with the requesting entity and aging information associated with the accounts receivable information, determine, based on the financial information, a borrowing base for the requesting entity, determine, based on the borrowing base and the advance amount, a status for the advance request, and send, over the network, information about the status for the advance request.

In another example, this disclosure describes a computer-readable storage medium comprises instructions that, when executed, configure processing circuitry of a computing system to maintain, for each of a plurality of entities, access credentials; receive, over a network, an advance request; identify, based on the advance request, a requesting entity associated with the advance request and an advance amount associated with the advance request, wherein the requesting entity is one of the plurality of entities; access, over the network using the access credentials for the requesting entity, financial information maintained by the requesting entity, wherein the financial information includes accounts receivable information associated with the requesting entity and aging information associated with the accounts receivable information; determine, based on the financial information, a borrowing base for the requesting entity; determine, based on the borrowing base and the advance amount, a status for the advance request; and send, over the network, information about the status for the advance request.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a conceptual diagram illustrating an example system within a supply chain finance ecosystem, in accordance with one or more aspects of the present disclosure.

FIG. 2 is a block diagram illustrating an example system within a supply chain finance ecosystem, in accordance with one or more aspects of the present disclosure.

FIG. 3A, FIG. 3B, FIG. 3C, and FIG. 3D are conceptual diagrams illustrating example user interfaces presented by a user interface device in accordance with one or more aspects of the present disclosure.

FIG. 4 is a flow diagram illustrating accounting operations performed by an example computing system lender computing system in accordance with one or more aspects of the present disclosure.

FIG. 5 is a flow diagram illustrating operations performed by an example computing system lender computing system in accordance with one or more aspects of the present disclosure.

### DETAILED DESCRIPTION

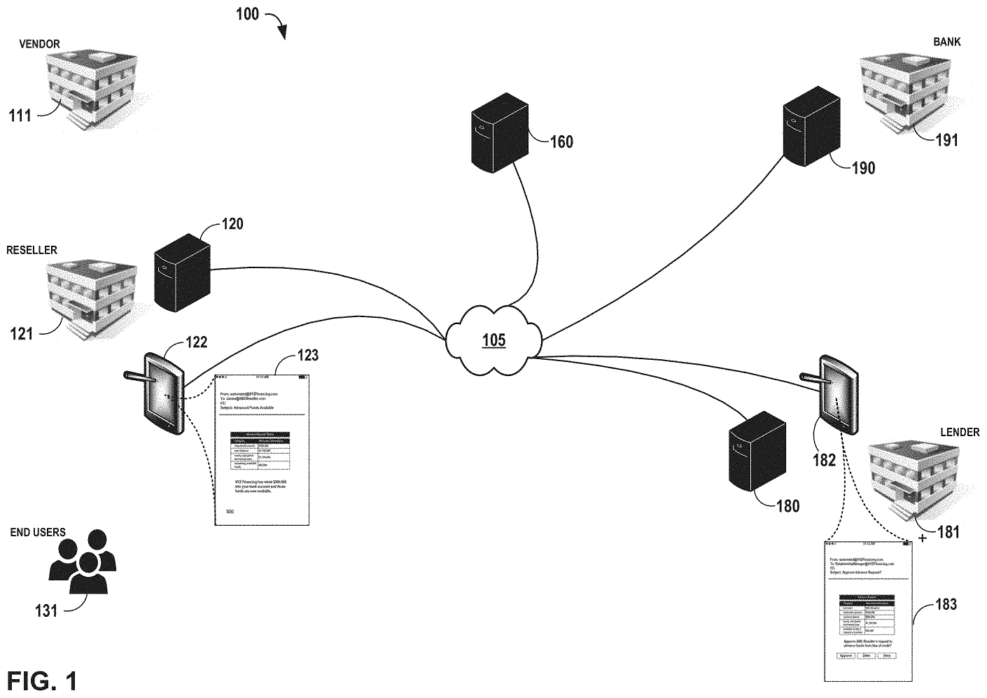

FIG. 1 is a conceptual diagram illustrating an example system within a supply chain finance ecosystem, in accordance with one or more aspects of the present disclosure. For the purpose of providing background, the illustration in FIG. 1 includes representations of a number entities, including one or more vendors 111, one or more resellers 121, and one or more end users 131. Also shown in FIG. 1 are one or more lenders 181 and one or more banks 191.

System 100 of FIG. 1 also includes one or more reseller computing systems 120, one or more reseller mobile devices 122, one or more accounting computing systems 160, one or more lender computing systems 180, one or more lender mobile devices 182, and one or more banking computing systems 190. Each of such devices are shown interconnected via network 105.

In a supply chain, such as that illustrated in FIG. 1, one or more supply chain participants may seek to optimize cash flow and/or working capital. For instance, in the example illustrated in FIG. 1, vendor 111 is a manufacturer of products. Reseller 121 purchases products from vendor 111, and resells those products (e.g., as inventory) to end users 131. Reseller 121 may couple the sales to end users 131 with services associated with the inventory (e.g., reseller 121 may provide installation, support, and/or distribution functions to end users 131). Accordingly, reseller 121 generates revenue through sales of products and/or services to end users 131. In some cases, reseller 121 purchases its inventory from vendor 111 before it can generate revenue through sales to end users 131.

Reseller 121 may therefore seek to optimize cash flow by contracting with a financing partner, such as lender 181. For instance, in the example of FIG. 1, lender 181 may provide financing (i.e., cash) to reseller 121 in the form of a line of credit secured by assets of reseller 121. Those assets may include any assets held or owned by reseller 121, and may include accounts receivables held by reseller 121. Typically, such accounts receivables may, in some examples, be amounts owed to reseller 121 by one or more end users 131. In some examples, reseller 121 and lender 181 contractually establish an initial maximum balance on the line of credit, based on collateral pledged by reseller 121. According to such an arrangement, lender 181 permits reseller 121 to access funds, as needed, through the line of credit. Typically, reseller 121 can access funds from the line of credit at any time, as long as reseller 121 does not exceed the established maximum amount, and as long as reseller 121 meets any other requirements established by lender 181. By partnering with lender 181 to obtain cash through a line of credit, reseller 121 may, for example, effectively lengthen payment terms to vendors 111 or otherwise optimize cash flow relating to, for example, purchases made from vendor 111 and sales made to end users 131.

In the example of FIG. 1, bank 191 is a financial institution or bank at which reseller 121 and lender 181 maintain accounts. For simplicity in the example of FIG. 1, both reseller 121 and lender 181 maintain accounts at the same bank 191, although in other examples, reseller 121 and lender 181 may, of course, maintain accounts at different financial institutions or banks. Also, in the example illustrated in FIG. 1, bank 191 is shown as an entity that is separate from lender 181. In some examples, however, bank 191 and lender 181 may be the same entity, or lender 181 and bank 191 may have a parent-subsidiary relationship or other affiliation. Further, although only one vendor 111 and one reseller 121 are illustrated in FIG. 1, lender 181 may provide services to many resellers 121, and each may have a business relationship with one or more vendors 111. Accordingly, techniques described herein may be performed not only over a network that connects lender computing system 180 with reseller computing system 120, but such techniques may also be performed over one or more networks that connect lender computing system 180 with multiple reseller computing systems 120, multiple accounting computing systems 160, multiple banking computing systems 190, and/or multiple other devices.

Reseller 121 may draw cash from the line of credit it holds with lender 181 through funds transfers from an account owned by lender 181 at bank 191 to an account owned by reseller 121 at bank 191. Conversely, reseller 121 may pay down the line of credit by making funds transfers from the account owned by reseller 121 to an account owned by lender 181. Although reseller 121 and lender 181 may agree on an initial maximum balance on the line of credit, based on collateral pledged by reseller 121, lender 181 may adjust this maximum balance in response to changes to a borrowing base associated with reseller 121. In general, the borrowing base is the amount of collateral that reseller 121 uses to secure the value of the line of credit. In some examples, the borrowing base may occasionally, periodically, or continually change, since the collateral pledged by reseller 121 can change as assets held by reseller 121 change. For example, the values of accounts receivables owned by reseller 121 may increase and decrease over time.

In the example of FIG. 1, and in accordance with one or more aspects of the present disclosure, lender computing system 180 may authenticate a user operating reseller mobile device 122. For example, reseller mobile device 122 detects input that it determines corresponds to authentication credentials from a user of reseller mobile device 122. Reseller mobile device 122 outputs a signal over network 105. Lender computing system 180 detects a signal over network 105. Lender computing system 180 determines that the signal corresponds to authentication credentials for a user that is authorized to access funds from the line of credit. Lender computing system 180 outputs a signal over network 105. Reseller mobile device 122 detects a signal and determines that the signal indicates that the user has been authenticated. In some examples, a wide variety of input types may be accepted by reseller mobile device 122 when authenticating a user. For example, reseller mobile device 122 may accept, for the purposes of authentication, input based on facial recognition, fingerprint identification, hand geometry biometrics, retina or iris scan information, voice or signature analysis, passcodes, passwords, information challenges, or any other input type now known or hereafter developed.

Lender computing system 180 may respond to a request to advance funds from the line of credit held by reseller 121. For instance, in the example of FIG. 1, reseller mobile device 122 detects input that it determines corresponds to a request to withdraw cash as an advance from the line of credit held by reseller 121 with lender 181. Reseller mobile device 122 outputs a signal over network 105. Lender computing system 180 receives a signal that it determines corresponds to a request, from an authorized user associated with reseller 121, to withdraw $800,000 from a line of credit held by reseller 121 with lender 181. Lender computing system 180 further determines that the request is from an authorized user associated with reseller 121, and that reseller 121 holds a $1,000,000 line of credit with lender 181. Lender computing system 180 further determines that the current balance on that line of credit is $0, and that therefore, the available funds on the line of credit exceeds the requested advance amount. Lender computing system 180 therefore automatically authorizes the withdrawal, and outputs a signal over network 105.

Banking computing system 190, which is controlled by bank 191, detects the signal output by lender computing system 180. Banking computing system 190 determines that the signal corresponds to authorization to transfer $800,000 to an account owned by reseller 121 from an account owned by lender 181. In the example of FIG. 1, banking computing system 190 also performs accounting functions relating to such a funds transfer. For example, banking computing system 190 adjusts accounting records to reflect the new balance of the line of credit held by reseller 121 with lender 181. Specifically, if the line of credit was previously unused, the balance is adjusted from $0 to $800,000, leaving $200,000 still available. Correspondingly, banking computing system 190 increases, by $800,000, the balance of the account owned by reseller 121 that receives the advanced funds. In the example of FIG. 1, reseller 121 may use the funds to purchase inventory from vendor 111.

Lender computing system 180 may provide information to a user of lender mobile device 182 about the funds transfer request initiated by reseller 121. The user of lender mobile device 182 may be a relationship manager employed by lender 181. For instance, in the example of FIG. 1, and in connection with authorizing the withdrawal, lender computing system 180 outputs a signal over network 105. Lender mobile device 182 detects a signal over network 105 and determines that the signal corresponds to information about the request to advance funds by reseller 121. Lender mobile device 182 generates data associated with a user interface and presents one or more user interfaces 183 at a display screen associated with lender mobile device 182. In some examples, one or more of user interfaces 183 presents information indicating that funds were transferred from the line of credit held by reseller 121 with lender 181.

Lender computing system 180 may confirm to a user of reseller mobile device 122 that funds were transferred. The user of reseller mobile device 122 may be an employee of reseller 121. For instance, in the example of FIG. 1, and also in connection with authorizing the withdrawal, lender computing system 180 outputs a signal over network 105. Reseller mobile device 122 detects a signal over network 105 and determines that the signal corresponds to information about the request to advance funds by reseller 121. Reseller mobile device 122 generates data associated with a user interface and presents one or more user interfaces 123 at a display screen associated with reseller mobile device 122, thereby informing a user of reseller mobile device 122 that funds were transferred from the line of credit held by reseller 121 with lender 181 to a cash account owned by reseller 121.

Reseller 121 may, during the normal course of business operations, maintain accounting records. In some examples, such accounting records may include records of accounts receivables, accounts payables, information about banking activity and credits and debits posted to bank and credit accounts. In the example of FIG. 1, reseller computing system 120 maintains accounting records for reseller 121 relating to business operations performed by reseller 121. For instance, in some examples, reseller computing system 120 detects input that it determines corresponds to information about business operations. Reseller computing system 120 determines, based on the information about business operations, accounting information. Reseller computing system 120 logs the accounting information in accounting records stored at reseller computing system 120 and/or updates accounting records stored at reseller computing system 120. Alternatively, or in addition, reseller computing system 120 outputs, in response to the detected input, a signal over network 105. Accounting computing system 160 detects a signal that it determines corresponds to accounting information associated with reseller 121. Accounting computing system 160 logs the accounting information in accounting records stored at accounting computing system 160 and/or updates accounting records stored at accounting computing system 160.

In some examples, accounting computing system 160 may act as a mirror of the accounting records maintained at reseller computing system 120. In other examples, accounting computing system 160 may act as a primary store of some or all accounting records maintained by reseller 121. In such an example, reseller 121 might not use reseller computing system 120 to maintain accounting records, but may instead use accounting computing system 160 or another remotely located system.

Also, in the example illustrated in FIG. 1, accounting computing system 160 is shown as implemented separately from lender computing system 180. In other examples, however, accounting computing system 160 may be combined with lender computing system 180 or with one or more other systems illustrated in FIG. 1. Further, accounting computing system 160 may, in some examples, be operated or controlled by one or more of reseller 121, lender 181, and/or bank 191.

Lender computing system 180 may respond to a request to advance further funds from the line of credit held by reseller 121. For instance, in the example of FIG. 1, reseller mobile device 122 detects input that it determines corresponds to a request to advance additional cash from the line of credit reseller 121 holds with lender 181. Reseller mobile device 122 outputs a signal over network 105. Lender computing system 180 detects a signal over network 105 that it determines corresponds to a request, from an authorized user associated with reseller 121, to withdraw an additional $300,000 from the $1,000,000 line of credit held by reseller 121 with lender 181. Lender computing system 180 determines that the current balance on the line of credit is $800,000, and that the remaining available line of credit is $200,000. Lender computing system 180 therefore does not, in this example, automatically authorize the withdrawal, since the advance request exceeds the available cash by $100,000.

Lender computing system 180 may analyze financial records maintained by reseller 121 at accounting computing system 160 to determine whether collateral pledged by reseller 121 is nevertheless sufficient to enable the advance request to be granted. For instance, continuing with the example of FIG. 1, lender computing system 180 outputs a signal over network 105. Accounting computing system 160 detects a signal and determines that the signal corresponds to a request for financial information sufficient to calculate a borrowing base for reseller 121. Accounting computing system 160 further determines that the signal originates from lender computing system 180, which accounting computing system 160 determines is authorized to access financial records associated with reseller 121 and maintained by reseller 121 at accounting computing system 160. Accounting computing system 160 outputs information over network 105. Lender computing system 180 detects a signal over network 105 and determines that the signal includes financial information associated with reseller 121. Lender computing system 180 further determines that the financial information is sufficient to calculate a borrowing base.

Lender computing system 180 calculates, based on the financial information, an updated borrowing base for reseller 121. In some examples, lender computing system 180 may determine that the value of the collateral pledged by reseller 121 has been increased because the value of the pledged assets have increased. For example, lender computing system 180 may determine that additional accounts receivables held by reseller 121 have been logged in accounting computing system 160. Lender computing system 180 may also decrease the value of the collateral pledged based on other information logged in accounting computing system 160, such as information about debts owed by reseller 121, or about accounts receivables no longer held by reseller 121. Accordingly, as a result of such adjustments, the borrowing base may increase or decrease relative to a previously-calculated borrowing base.

In the example of FIG. 1, lender computing system 180 determines that the updated borrowing base for reseller 121 is $1,150,000. Lender computing system 180 further determines that based on the updated borrowing base, the request to withdraw $300,000 will not exceed the current borrowing base associated with reseller 121, since it will result in a line of credit balance of only $1,100,000. Accordingly, in such an example, lender computing system 180 outputs a signal over network 105. Lender mobile device 182 detects a signal over network 105 and determines that the signal corresponds to information about the request to withdraw $300,000. Lender mobile device 182 generates data associated with a user interface and presents one or more user interfaces 183 at a display device associated with lender mobile device 182. In some examples, one or more of user interfaces 183 include information about the request and the updated borrowing base calculation. One or more of user interfaces 183 may request approval to grant the request to advance funds. Lender mobile device 182 detects input that it determines corresponds to an approval to advance funds. Lender mobile device 182 outputs a signal over network 105. Lender computing system 180 detects a signal over network 105 that it determines corresponds to an approval of the request to advance $300,000. In response, lender computing system 180 authorizes and/or enables the withdrawal, and outputs a signal over network 105. Banking computing system 190 detects a signal that it determines corresponds to authorization to transfer $300,000 to an account owned by reseller 121 from an account owned by lender 181. Banking computing system 190 causes the funds to be transferred from the line of credit maintained by reseller 121, and performs accounting functions relating to the funds transfer, including adjusting the balance on the line of credit that reseller 121 maintains with lender 181 to $1,100,000, leaving $50,000 still available.

Lender computing system 180 may confirm to a user of reseller mobile device 122 that funds were transferred. For instance, in the example of FIG. 1, lender computing system 180 outputs a signal over network 105. Reseller mobile device 122 detects a signal over network 105 and determines that the signal corresponds to information about the latest request to advance funds. Reseller mobile device 122 generates data associated with a user interface and presents one or more user interfaces 123 at a display screen associated with reseller mobile device 122. In some examples, one or more user interfaces present information confirming that funds were transferred from the line of credit held by reseller 121 with lender 181. Further, in some examples, lender computing system 180 may send one or more other notifications to reseller mobile device 122 in connection with the request to advance funds. For instance, lender computing system 180 may send an earlier notification to reseller mobile device 122 confirming the advance request was received. Alternatively, or in addition, lender computing system 180 may send a notification when the advance request was authorized or approved by lender 181.

In examples just described, some advance requests might be granted automatically, some might be granted after lender computing system 180 determines a new borrowing base, and/or some might be granted after approval by an agent of the lender. Alternate practices could also be followed. For instance, in some examples, lender computing system 180 might determine an updated borrowing base each time lender computing system 180 receives an advance request. In other examples, lender computing system 180 might determine an updated borrowing base each time financial records stored at accounting computing system 160 (or elsewhere) are updated. In still further examples, lender computing system 180 might determine a borrowing base occasionally, periodically, pursuant to a schedule, or continually. Lender computing system 180 might also determine a borrowing base based on the advance request itself or other circumstances. For instance, if granting the advance request will result in a line of credit balance that exceeds a certain dollar amount, or a certain percentage of the size of the line of credit, lender computing system 180 might determine an updated borrowing base in such examples.

Further, in some examples, lender computing system 180 might automatically determine whether to grant some or all advance requests based on an updated borrowing base for the requesting entity, without requiring confirmation from an agent of reseller 121. In other examples, lender computing system 180 might request confirmation from an agent of reseller 121 before authorizing some or all advance requests. In still further examples, lender computing system 180 might request confirmation only for those advance requests that will result in a line of credit balance that exceeds a certain dollar amount, or a certain percentage of the size of the line of credit.

FIG. 1 illustrates one example implementation of system 100. Other example or alternate implementations of system 100 may be appropriate in other instances. Such implementations may include a subset of the devices and/or components included in the example of FIG. 1 and/or may include additional devices and/or components not shown in FIG. 1.

Accordingly, although one or more implementations of system 100 have been described with reference to FIG. 1, system 100 may be implemented in a number of different ways. For instance, one or more devices of system 100 that may be illustrated as separate devices may alternatively be implemented as a single device; one or more components of system 100 that may be illustrated as separate components may alternatively be implemented as a single component. Also, in some examples, one or more devices of system 100 that may be illustrated as a single device may alternatively be implemented as multiple devices; one or more components of system 100 that may be illustrated as a single component may alternatively be implemented as multiple components. Each of the multiple devices and/or components may be directly coupled via wired or wireless communication and/or remotely coupled via one or more networks. Also, one or more devices or components that may be illustrated in FIG. 1 may alternatively be implemented as part of another device or component not shown in FIG. 1.

Further, certain operations, techniques, features, and/or functions may have been described herein as being performed by specific components, devices, and/or modules in FIG. 1. In other examples, such operations, techniques, features, and/or functions may be performed by different components, devices, or modules. Accordingly, some operations, techniques, features, and/or functions that may have been described herein as being attributed to one or more components, devices, or modules in FIG. 1 may, in other examples, be attributed to other components, devices, and/or modules, even if not specifically described herein in such a manner.

In accordance with one or more aspects of this disclosure, one or more lender computing systems 180 may analyze information associated with one or more resellers 121, such as information stored at accounting computing system 160. It may be appropriate for one or more lender computing systems 180 to analyze such information only after receiving permission from the owner or user associated with such information. For example, in some examples described herein, before lender computing system 180 can collect or make use of information associated with reseller 121, reseller 121 may be provided with an opportunity to control whether lender computing system 180 can collect or make use of information about the user (e.g., banking transactions, financial information, or other information), or to dictate whether and/or how lender computing system 180 can use such information.

Through techniques in accordance with one or more aspects of the present disclosure, such as calculating borrowing base information based on reseller financial information maintained by the reseller, lender computing system 180 may avoid having to perform periodic calculations based on data entered by a user. By not having to perform periodic calculations based on data entered by a user, lender computing system 180 may require less user input, and may generate more accurate and timely borrowing base determinations. Further, by not having to perform periodic calculations based on data entered by a user, lender computing system 180 and/or other systems may spend less computing cycles processing user input or correcting user input, and thereby consume less electrical power. Therefore, aspects of this disclosure may improve the function of at least some computing systems because calculating borrowing base information based on reseller financial information maintained by the reseller may have the effect of causing lender computing system 180 or other systems to consume less electrical power.

Further, through techniques in accordance with one or more aspects of the present disclosure, such as calculating borrowing base information based on reseller financial information maintained by the reseller, lender computing system 180 may operate on more accurate underlying data. By operating on more accurate underlying data, lender computing system 180 may make more accurate collateral assessments and more accurate borrowing base determinations. Therefore, aspects of this disclosure may improve the function of lender computing system 180 because calculating borrowing base information based on reseller financial information maintained by the reseller may have the effect of causing lender computing system 180 to make more accurate collateral assessments and more accurate borrowing base determinations.

Further, through techniques in accordance with one or more aspects of the present disclosure, such as calculating borrowing base information based on reseller financial information maintained by the reseller, lender computing system 180 may enable cash advance requests to be approved more quickly. By enabling advance requests to be approved more quickly, various aspects of system 100 may operate more efficiently because quick decisions on advance requests reduce or eliminate reseller and business uncertainty that accompanies delays in processing advance requests. Therefore, aspects of this disclosure may improve the function of at least some aspects of system 100 because calculating borrowing base information based on reseller financial information maintained by the reseller may have the effect of causing system 100 to operate more efficiently.

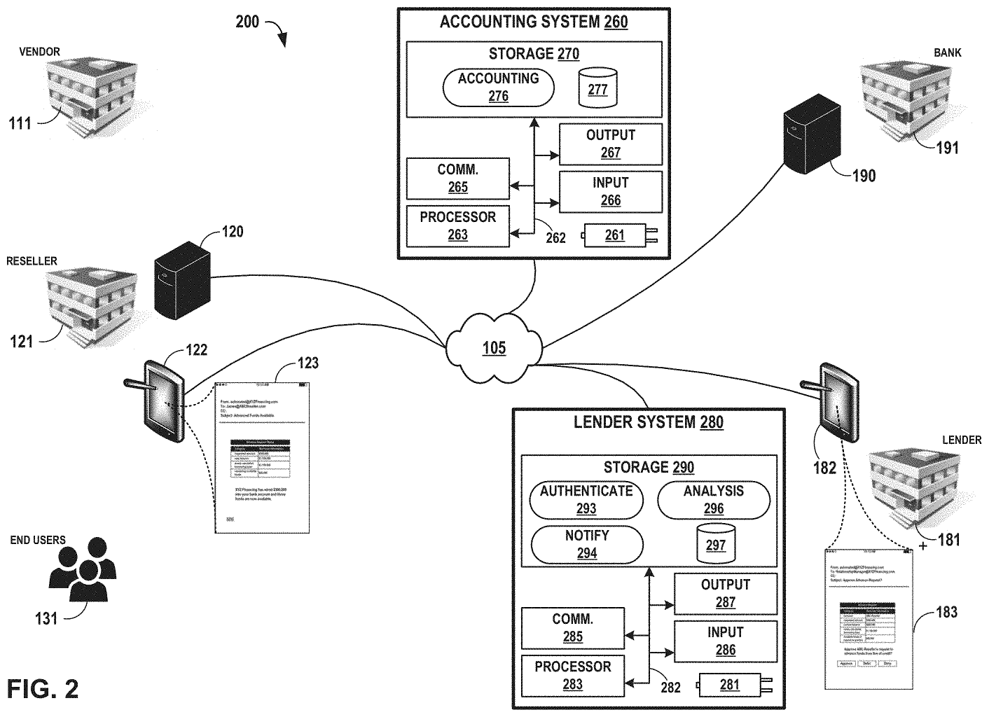

FIG. 2 is a block diagram illustrating an example system within a supply chain finance ecosystem, in accordance with one or more aspects of the present disclosure. System 200 of FIG. 2 may be described as an example or alternate implementation of system 100 of FIG. 1. One or more aspects of FIG. 2 may be described herein within the context of FIG. 1.

In the example of FIG. 2, system 200 includes one or more reseller computing systems 120, one or more reseller mobile devices 122, one or more accounting systems 260, one or more lender computing systems 280, one or more lender mobile devices 182, and one or more banking computing systems 190. Each of such devices are shown connected via network 105.

Systems, devices, or components illustrated in FIG. 2 may correspond to like-numbered systems, devices, or components illustrated in FIG. 1, and may be implemented in a manner consistent with the description provided in connection with FIG. 1. Also, lender computing system 280 of FIG. 2 may correspond to lender computing system 180 of FIG. 1, and accounting system 260 of FIG. 2 may correspond to accounting computing system 160 of FIG. 1. These systems may be implemented in a manner consistent with the description of the corresponding system provided in connection with FIG. 1, although in some examples such systems may involve alternate implementations with more, fewer, and/or different capabilities. For ease of illustration, and in at least some cases, one system of a given type is illustrated in FIG. 2 (e.g., only one lender computing system 280 and only one accounting system 260 is illustrated in FIG. 2), although techniques in accordance with one or more aspects of this disclosure may be performed with many more of such systems.

Network 105 may be the internet, or may include or represent any public or private communications network or other network. For instance, network 105 may be a cellular, Wi-Fi®, ZigBee, Bluetooth, Near-Field Communication (NFC), satellite, enterprise, service provider, and/or other type of network enabling transfer of transmitting data between computing systems, servers, and computing devices. One or more of client devices, server devices, or other devices may transmit and receive data, commands, control signals, and/or other information across network 105 using any suitable communication techniques. Network 105 may include one or more network hubs, network switches, network routers, satellite dishes, or any other network equipment. Such devices or components may be operatively inter-coupled, thereby providing for the exchange of information between computers, devices, or other components (e.g., between one or more client devices or systems and one or more server devices or systems). Each of the devices or systems illustrated in FIG. 2 may be operatively coupled to network 105 using one or more network links. The links coupling such devices or systems to network 105 may be Ethernet, Asynchronous Transfer Mode (ATM) or other types of network connections, and such connections may be wireless and/or wired connections. One or more of the devices or systems illustrated in FIG. 2 or otherwise on network 105 may be in a remote location relative to one or more other illustrated devices or systems.

Lender computing system 280 may be implemented as any suitable computing system, such as one or more server computers, workstations, mainframes, appliances, cloud computing systems, virtual machines, containers, and/or other computing systems that may be capable of performing operations and/or functions described in accordance with one or more aspects of the present disclosure. In some examples, lender computing system 280 represents a cloud computing system, server farm, and/or server cluster (or portion thereof) that provides services to client devices and other devices or systems. In other examples, lender computing system 280 may represent or be implemented through one or more virtualized compute instances (e.g., virtual machines, containers) of a data center, cloud computing system, server farm, and/or server cluster.

In the example of FIG. 2, lender computing system 280 may include power source 281, one or more processors 283, one or more input devices 286, one or more output devices 287, and one or more storage devices 290. Storage devices 290 may include authentication module 293, notification module 294, analysis module 296, and data store 297. One or more of the devices, modules, storage areas, or other components of lender computing system 280 may be interconnected to enable inter-component communications (physically, communicatively, and/or operatively). In some examples, such connectivity may be provided by through communication channels (e.g., communication channels 282), a system bus, a network connection, an inter-process communication data structure, or any other method for communicating data.

Power source 281 may provide power to one or more components of lender computing system 280. Power source 281 may receive power from the primary alternating current (AC) power supply in a building, home, or other location. In other examples, power source 281 may be a battery or a device that supplies direct current (DC). In still further examples, lender computing system 280 and/or power source 281 may receive power from another source. One or more of the devices or components illustrated within lender computing system 280 may be connected to power source 281, and/or may receive power from power source 281. Power source 281 may have intelligent power management or consumption capabilities, and such features may be controlled, accessed, or adjusted by one or more modules of lender computing system 280 and/or by one or more processors 283 to intelligently consume, allocate, supply, or otherwise manage power.

One or more processors 283 of lender computing system 280 may implement functionality and/or execute instructions associated with lender computing system 280 or associated with one or more modules illustrated herein and/or described below. One or more processors 283 may be, may be part of, and/or may include processing circuitry that performs operations in accordance with one or more aspects of the present disclosure. Examples of processors 283 include microprocessors, application processors, display controllers, auxiliary processors, one or more sensor hubs, and any other hardware configured to function as a processor, a processing unit, or a processing device. Lender computing system 280 may use one or more processors 283 to perform operations in accordance with one or more aspects of the present disclosure using software, hardware, firmware, or a mixture of hardware, software, and firmware residing in and/or executing at lender computing system 280.

One or more communication units 285 of lender computing system 280 may communicate with devices external to lender computing system 280 by transmitting and/or receiving data, and may operate, in some respects, as both an input device and an output device. In some examples, communication unit 285 may communicate with other devices over a network. In other examples, communication units 285 may send and/or receive radio signals on a radio network such as a cellular radio network. In other examples, communication units 285 of lender computing system 280 may transmit and/or receive satellite signals on a satellite network such as a Global Positioning System (GPS) network. Examples of communication units 285 include a network interface card (e.g. such as an Ethernet card), an optical transceiver, a radio frequency transceiver, a GPS receiver, or any other type of device that can send and/or receive information. Other examples of communication units 285 may include devices capable of communicating over Bluetooth®, GPS, NFC, ZigBee, and cellular networks (e.g., 3G, 4G, 5G), and Wi-Fi® radios found in mobile devices as well as Universal Serial Bus (USB) controllers and the like. Such communications may adhere to, implement, or abide by appropriate protocols, including Transmission Control Protocol/Internet Protocol (TCP/IP), Ethernet, Bluetooth, NFC, or other technologies or protocols.

One or more input devices 286 may represent any input devices of lender computing system 280 not otherwise separately described herein. One or more input devices 286 may generate, receive, and/or process input from any type of device capable of detecting input from a human or machine. For example, one or more input devices 286 may generate, receive, and/or process input in the form of electrical, physical, audio, image, and/or visual input (e.g., peripheral device, keyboard, microphone, camera).

One or more output devices 287 may represent any output devices of lender computing system 280 not otherwise separately described herein. One or more output devices 287 may generate, receive, and/or process input from any type of device capable of detecting input from a human or machine. For example, one or more output devices 287 may generate, receive, and/or process output in the form of electrical and/or physical output (peripheral device, actuator). Some devices may serve as both input and output devices. For example, a communication device may both send and receive data to and from other systems or devices over a network.

One or more storage devices 290 within lender computing system 280 may store information for processing during operation of lender computing system 280. Storage devices 290 may store program instructions and/or data associated with one or more of the modules described in accordance with one or more aspects of this disclosure. One or more processors 283 and one or more storage devices 290 may provide an operating environment or platform for such modules, which may be implemented as software, but may in some examples include any combination of hardware, firmware, and software. One or more processors 283 may execute instructions and one or more storage devices 290 may store instructions and/or data of one or more modules. The combination of processors 283 and storage devices 290 may retrieve, store, and/or execute the instructions and/or data of one or more applications, modules, or software. Processors 283 and/or storage devices 290 may also be operably coupled to one or more other software and/or hardware components, including, but not limited to, one or more of the components of lender computing system 280 and/or one or more devices or systems illustrated as being connected to lender computing system 280.

In some examples, one or more storage devices 290 are temporary memories, meaning that a primary purpose of the one or more storage devices is not long-term storage. Storage devices 290 of lender computing system 280 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Storage devices 290, in some examples, also include one or more computer-readable storage media. Storage devices 290 may be configured to store larger amounts of information than volatile memory. Storage devices 290 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories.

Authentication module 293 may perform functions relating to authenticating a user of a client computing device, often one that is operated by a user associated with reseller 121. Authentication module 293 may perform analyze authentication credentials received by communication unit 285 over network 105, and compare the authentication credentials to a list or hashed list of credentials associated with authorized users. In doing so, authentication module 293 may access data store 297. Although authentication module 293 may be described in connection with FIG. 2 as primarily performing authentication services, authentication module 293 may alternatively, or in addition, operations relating to identifying users and/or entities associated with users.

Notification module 294 may perform functions relating to communicating with computing devices to provide information about the status of a request to advance funds, to prompt a relationship manager associated with lender 181 to approve or otherwise act on a request to advance funds, to provide information about cross-selling or upselling opportunities (e.g., to a relationship manager associated with reseller 121), or to provide other information. Notification module 294 may receive information from one or more other modules, including analysis module 296. Although notification module 294 may be described in connection with FIG. 2 as primarily providing information to mobile devices, notification module 294 may alternatively, or in addition, provide information to other computing devices or systems.

Analysis module 296 may perform functions relating to performing borrowing base calculations and/or identifying potential cross-selling and/or upselling opportunities. Analysis module 296 may request, from accounting system 260, financial information that can be used to determine a borrowing base for one or more resellers 121. Analysis module 296 may analyze financial information received from accounting system 260 and determine a value of the collateral pledged by one or more resellers 121 by evaluating, for example, accounts receivables information and aging information relating to the accounts receivables information. Analysis module 296 may also access other information sources, which may include information stored locally or remotely relative to lender computing system 280. Analysis module 296 may analyze financial information received from accounting system 260 and identify, based on banking records or other records, cross-selling and upselling information relating to one or more resellers 121. Analysis module 296 may output information to, or receive information from, one or more other modules (e.g., notification module 294).

Data store 297 may represent any suitable data structure or storage medium for storing information relating to records of financial transactions associated with one or more resellers 121 and/or other entities, and information relating to cross-selling and/or upselling opportunities or potential opportunities involving one or more resellers 121 and/or other entities. Data store 297 may further include access credentials for one or more of multiple resellers 121. Such access credentials may enable lender computing system 280 to access, at accounting system 260, financial information about each of resellers 121. The information stored in data store 297 may be searchable and/or categorized such that one or more modules within lender computing system 280 may provide an input requesting information from data store 297, and in response to the input, receive information stored within data store 297. Data store 297 may be primarily maintained by analysis module 296. Data store 297 may store financial information for one or more resellers 121. Such financial information may include information retrieved from accounting system 260 over network 105. Data store 297 may provide other modules with access to the data stored within data store 297, and/or may analyze the data stored within data store 297 and output such information on behalf of other modules of lender computing system 280.

Accounting system 260 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, accounting system 260 represents a cloud computing system, server farm, and/or server cluster (or portion thereof) that provides services to client devices and other devices or systems. In other examples, accounting system 260 may represent or be implemented through one or more virtualized compute instances (e.g., virtual machines, containers) of a data center, cloud computing system, server farm, and/or server cluster. In some examples, accounting system 260 may be implemented as a cloud-based accounting and/or recordkeeping system, such as QuickBooks Online, which is a service provided by Intuit Inc., of Mountain View, Calif.

In the example of FIG. 2, accounting system 260 may include power source 261, one or more processors 263, one or more communication units 265, one or more input devices 266, one or more output devices 267, and one or more storage devices 270. Storage devices 270 may include accounting module 276 and data store 277. One or more of the devices, modules, storage areas, or other components of accounting system 260 may be interconnected to enable inter-component communications (physically, communicatively, and/or operatively). In some examples, such connectivity may be provided by through communication channels (e.g., power sources 261), a system bus, a network connection, an inter-process communication data structure, or any other method for communicating data.

Power source 261 may provide power to one or more components of accounting system 260. One or more processors 263 of accounting system 260 may implement functionality and/or execute instructions associated with accounting system 260 or associated with one or more modules illustrated herein and/or described below. One or more communication units 265 of accounting system 260 may communicate with devices external to accounting system 260 by transmitting and/or receiving data over a network or otherwise. One or more input devices 266 may represent any input devices of accounting system 260. One or more output devices 267 may represent any output devices of accounting system 260. One or more storage devices 270 within computing system 260 may store program instructions and/or data associated with one or more of the modules of storage devices 270, in accordance with one or more aspects of this disclosure. One or more processors 263 and one or more storage devices 270 may provide an operating environment or platform for such modules. Power source 261, processors 263, communication units 265, input devices 266, output devices 267, and/or storage devices 270 may be implemented in a manner similar to or consistent with like-named components described herein, such as those described connection with lender computing system 280.

Accounting module 276 may perform functions relating to maintaining accounting records for one or more resellers 121. Accounting module 276 may receive, over network 105, information about business operations or transactions from one or more resellers 121. Accounting module 276 may analyze such information and determine appropriate accounting entries to be made to accounting records maintained by accounting module 276 for one or more resellers 121. Accounting module 276 may log, in data store 277, information about business operations performed by one or more resellers 121 or other entities. Accounting module 276 may periodically, occasionally, or continually access, over network 105, information about banking activity associated with bank accounts owned or controlled by one or more resellers 121. Accounting module 276 may determine whether a computing system (e.g., lender computing system 280) is authorized to access financial records associated with reseller 121 and maintained by reseller 121 at accounting system 260. Although accounting module 276 may be described in connection with FIG. 2 as primarily performing accounting operations, accounting module 276 may alternatively, or in addition, perform operations including analysis of data received from one or more resellers 121 or other entities.

Data store 277 may represent any suitable data structure or storage medium for storing accounting records and/or other financial information for one or more resellers 121. The information stored in data store 277 may be searchable and/or categorized such that one or more modules within accounting system 260 may provide an input requesting information from data store 277, and in response to the input, receive information stored within data store 277. Data store 277 may be primarily maintained by accounting module 276. Data store 277 may provide other modules with access to the data stored within data store 277, and/or may analyze the data stored within data store 277 and output such information on behalf of other modules of accounting system 260.

In the example of FIG. 2, and in accordance with one or more aspects of the present disclosure, reseller 121 may, during the normal course of business operations, maintain accounting records at accounting system 260. For instance, in the example of FIG. 2, reseller computing system 120 detects input that it determines corresponds to information about a newly acquired claim for payment that reseller 121 holds against one or more end users 131. In response to such input, reseller computing system 120 outputs a signal over network 105. Communication unit 265 of accounting system 260 detects a signal over network 105. Communication unit 265 outputs to accounting module 276 information about the signal. Accounting module 276 determines that the signal corresponds to information about the claim for payment that reseller 121 holds against one or more end users 131. Accounting module 276 outputs to data store 277 information about the claim. Data store 277 stores and/or logs information about the claim as an accounts receivable asset associated with reseller 121.

Reseller 121 may, during business operations, update the accounting records at accounting system 260. For instance, in the example of FIG. 2, reseller computing system 120 detects input that it determines corresponds to information about a payment received for an accounts receivable. In response to the input, reseller computing system 120 outputs a signal over network 105. Communication unit 265 detects a signal over network 105 and outputs to accounting module 276 information about the signal. Accounting module 276 determines that the signal corresponds to information about payment received by reseller 121 (or by a bank account owned by reseller 121) that corresponds to an accounts receivable accounting entry. Accounting module 276 outputs to data store 277 information about the payment. Data store 277 stores and/or logs information about the payment.

Other accounting records associated with reseller 121 may be maintained and/or updated at accounting system 260. For instance, in the example of FIG. 2, reseller computing system 120 detects input that it determines corresponds to information about a claim for payment that a third party holds against reseller 121. In response to the input, reseller computing system 120 outputs a signal over network 105. Communication unit 265 of accounting system 260 detects a signal over network 105 and outputs to accounting module 276 information about the signal. Accounting module 276 determines that the signal corresponds to information about an accounts payable associated with reseller 121. Accounting module 276 outputs information to data store 277, and data store 277 stores and/or logs information about the accounts payable.

In another example, reseller computing system 120 may communicate to accounting system 260, over network 105, information about banking activity associated with one or more bank accounts owned by reseller 121. Banking activity may include types of charges incurred, checks written, names of creditors, names of debtors, amounts paid or received. In such an example, accounting module 276 of accounting system 260 may store and/or log such information within data store 277. Alternatively, or in addition, accounting module 276 of accounting system 260 may periodically, occasionally, or continually access, over network 105, information about banking activity associated with one or more bank accounts owned by reseller 121. For instance, accounting module 276 of accounting system 260 may access banking computing system 190 over network 105. Accounting module 276 may store and/or log information about banking activity in data store 277.

Accounting system 260 may be implemented in a variety of ways. For instance, in some examples, accounting system 260 may serve as a primary accounting system for reseller 121. In other examples, accounting system 260 may act as a full or partial mirror of another accounting system used by reseller 121. In still other examples, accounting system 260 may serve as an accounting system for only certain aspects of the business operated by reseller 121. In still other examples, accounting system 260 may be integrated into one or more systems or components of FIG. 2, such as banking computing system 190 or lender computing system 280.

Lender computing system 280 may authenticate a user that is authorized to access funds, on behalf of reseller 121, from the line of credit held by reseller 121 with lender 181. For instance, in the example of FIG. 2, reseller mobile device 122 detects input that it determines corresponds to authentication credentials from a user of reseller mobile device 122. Reseller mobile device 122 outputs a signal over network 105. Communication unit 285 of lender computing system 280 detects a signal over network 105 and outputs information about the signal to authentication module 293. Authentication module 293 determines that the signal corresponds to authentication credentials for a user that is authorized to access funds from the line of credit held by reseller 121 with lender 181. Authentication module 293 compares the credentials to credentials or hashed credentials stored within data store 297. Authentication module 293 causes communication unit 285 to output a signal over network 105. Reseller mobile device 122 detects a signal and determines that the signal indicates that the user has been authenticated.

Lender computing system 280 may collect information to calculate a borrowing base for reseller 121. For instance, in the example of FIG. 2, communication unit 285 of lender computing system 280 detects a signal over network 105. Communication unit 285 outputs an indication of the signal to analysis module 296. Analysis module 296 determines that the signal corresponds to a request, from an authorized user associated with reseller 121, to advance funds from a line of credit held by reseller 121 with lender 181. In response, analysis module 296 causes communication unit 285 to output a signal over network 105 that includes access credentials for accessing information about reseller 121 at accounting system 260. Communication unit 265 of accounting system 260 detects a signal and outputs to accounting module 276 information about the signal. Accounting module 276 determines that the signal includes access credentials. Accounting module 276 further determines that the signal originates from lender computing system 280, which accounting module 276 also determines is authorized to access financial records associated with reseller 121 and maintained by reseller 121 at accounting system 260. Accounting module 276 further determines that the signal corresponds to a request for financial information about reseller 121. Accounting module 276 accesses data store 277 and causes communication unit 265 to output information over network 105. Communication unit 285 detects a signal over network 105 and outputs to analysis module 296 information about the signal. Analysis module 296 determines that the signal includes information that can be used to perform a borrowing base calculation.

Analysis module 296 calculates, based on the financial information received from accounting system 260 as well as further information, an updated borrowing base for reseller 121. In some examples, analysis module 296 calculates a borrowing base for reseller 121 based on information about inventory, accounts receivables, accounts payables, and aging information for accounts receivables and payables. Such information may be derived from sales journals, collections journals, debit and/or credit memo journals. For instance, in some examples, analysis module 296 may access data store 297 and analyze historical information about reseller 121, information about previous advances requested by reseller 121, and information current balances associated with one or more lines of credit held by reseller 121 with lender 181.

Analysis module 296 may calculate the borrowing base by totaling the values of all pledged collateral, accounts receivables, and other designated assets, and then applying certain adjustments. For instance, analysis module 296 may determine that the value of the collateral pledged by reseller 121 has been increased because the value of the pledged assets have increased based on certain new accounts receivables held by reseller 121 and logged in data store 277 of accounting system 260. Analysis module 296 may also decrease the value of the collateral pledged based on other information logged in data store 277 of accounting system 260, such as information about accounts payables, debts owed by reseller 121, or about accounts receivables no longer held by reseller 121. For instance, reseller 121 may have an accounts receivable for a third party, but may also have an accounts payable for that same third party. In such a situation, the value that the accounts receivable increases the borrowing base might be decreased or offset by the value of the accounts payable for that same third party.

Further, some accounts receivables, accounts payables, and/or other assets might be disqualified or determined to be ineligible for inclusion in the borrowing base calculation. For instance, accounts receivables that are more than a certain age (e.g., 90 days) might be declared ineligible. Also, one or more assets, such as an accounts receivable, might be declared ineligible for inclusion in a borrowing base calculation for other reasons, such as receivables characterized as cross-aged, or those associated with individuals, affiliate companies, government entities, foreign companies, and/or other identified entities. Further, some assets might be declared ineligible or reduced in value based on other circumstances that might weaken the claim associated with the asset (e.g., an accounts receivable claim) or that might otherwise weaken the lender's ability to convert the underlying asset into cash.

In some examples, the borrowing base is that amount that a lender might consider likely to be able to liquidate easily if necessary. Accordingly, although some borrowing base calculations might include assets such as equipment, real estate, other hard assets, and/or inventory, other borrowing base calculations might not include one or more of such items. In some examples, a borrowing base might only include assets that would be relatively easy to convert into cash. Such assets would include bank accounts and accounts receivables, for example. Further, the total value of the assets might, in some examples, be discounted or margined by a percentage, thereby further reducing the borrowing base. As a result of the various adjustments described above, a borrowing base may increase or decrease over time.

In some examples, analysis module 296 may calculate a borrowing base each time a request to advance funds is received. In other examples, analysis module 296 may calculate a borrowing base occasionally or periodically (e.g., hourly, daily, weekly). In still other examples, analysis module 296 may calculate a borrowing base only when a request to advance funds would result in outstanding credit that exceeds the maximum current amount, or exceeds a given percentage of the maximum credit amount. For example, analysis module 296 may calculate a borrowing base each time a request to advance funds will result in a balance on the line of credit that exceeds a fixed percentage (e.g., 80%, 90%) of the maximum credit amount. In still other examples, analysis module 296 might determine an updated a borrowing base at other times, or in response to other circumstances.

Modules illustrated in FIG. 2 (e.g., accounting module 276, authentication module 293, analysis module 296, notification module 294) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

FIG. 2 illustrates one example implementation of system 200. Other example or alternate implementations of system 200 may be appropriate in other instances. Such implementations may include a subset of the devices and/or components included in the example of FIG. 2 and/or may include additional devices and/or components not shown in FIG. 2. Accordingly, although one or more implementations of system 200 have been described with reference to FIG. 2, system 200 may be implemented in a number of different ways.

For instance, one or more devices of system 200 that are illustrated as separate devices may be implemented as a single device; one or more components of system 200 that are illustrated as separate components may be implemented as a single component. Also, in some examples, one or more devices of system 200 that are illustrated as a single device may be implemented as multiple devices; one or more components of system 200 that are illustrated as a single component may be implemented as multiple components. Each of the multiple devices and/or components may be directly coupled via wired or wireless communication and/or remotely coupled via one or more networks. Also, one or more devices or components illustrated in FIG. 2 may also be implemented as part of another device or component not shown in FIG. 2. In this and other ways, some of the functions described herein may be performed via distributed processing by two or more devices.

Further, certain operations, techniques, features, and/or functions have been described herein as being performed by specific components, devices, and/or modules in FIG. 2. In other examples, such operations, techniques, features, and/or functions may be performed by different components, devices, or modules. Accordingly, some operations, techniques, features, and/or functions described herein as being attributed to one or more components, devices, or modules in FIG. 2 may, in other examples, be attributed to other components, devices, and/or modules, even if not specifically described herein in such a manner.

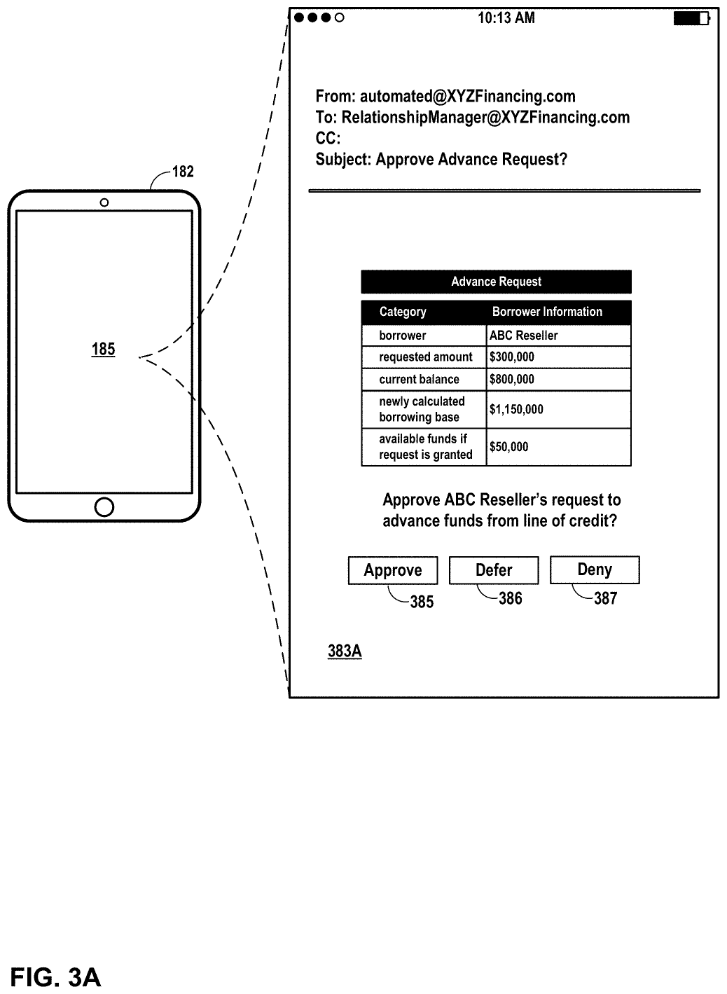

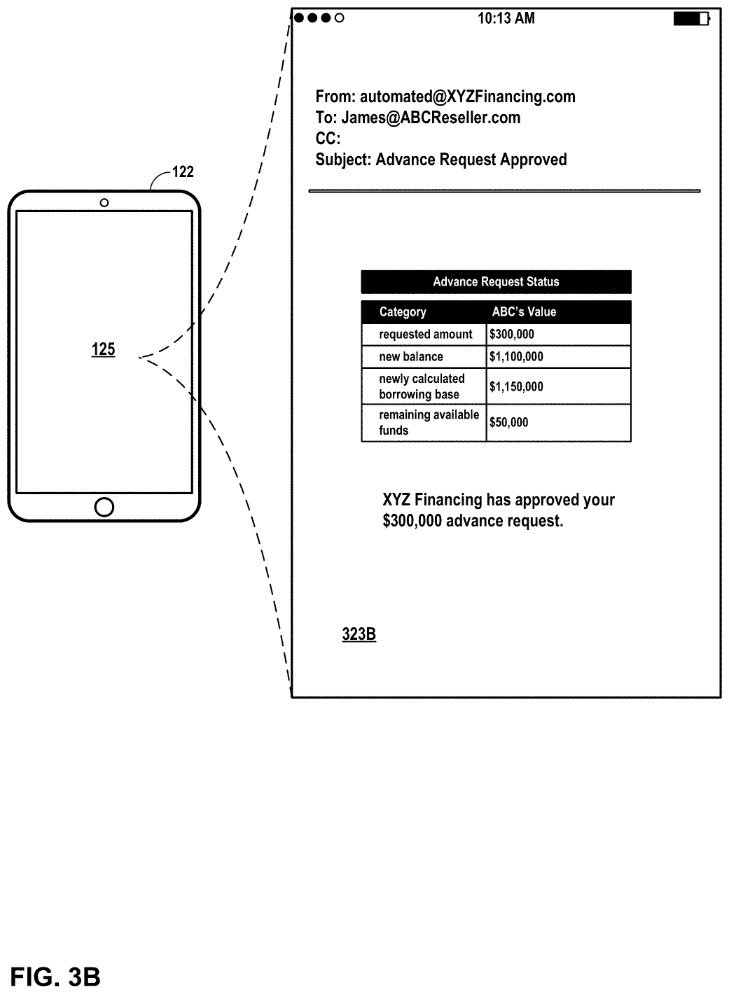

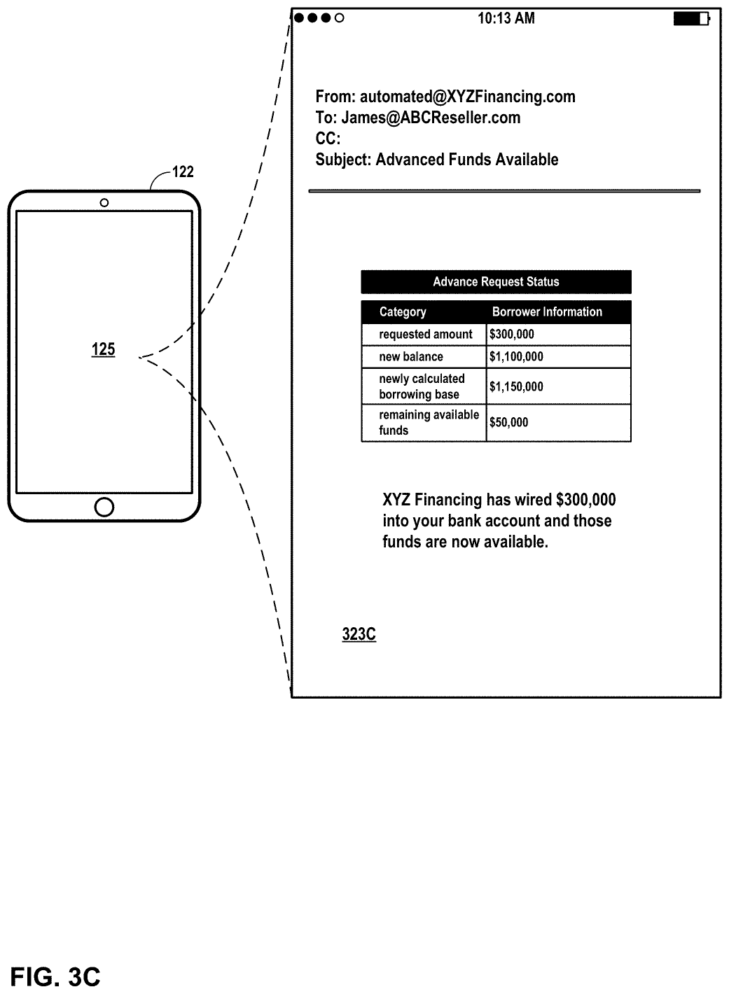

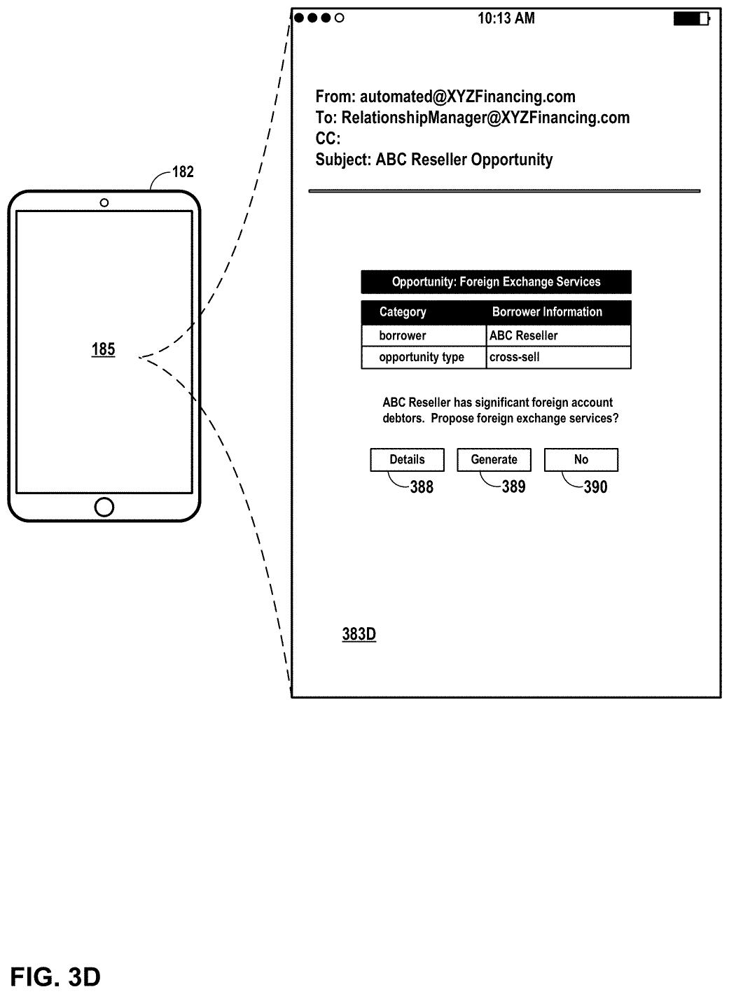

FIG. 3A, FIG. 3B, FIG. 3C, and FIG. 3D are conceptual diagrams illustrating example user interfaces presented by a user interface device in accordance with one or more aspects of the present disclosure. The user interfaces illustrated in FIG. 3A and FIG. 3D may correspond to a user interface presented by lender mobile device 182 of FIG. 1. The user interfaces illustrated in FIG. 3B and FIG. 3C may correspond to a user interface presented by reseller mobile device 122 of FIG. 1.

Although the user interfaces illustrated in FIG. 3A through FIG. 3D are shown as graphical user interfaces, other types of interfaces may be presented by lender mobile device 182 and/or reseller mobile device 122, including a text-based user interface, a console or command-based user interface, a voice prompt user interface, or any other appropriate user interface. One or more aspects of the user interfaces illustrated in FIG. 3A through FIG. 3D may be described herein within the context of system 200 of FIG. 2.

FIG. 3A illustrates an example user interface that may be presented by a computing device as a result of receiving information about a request for an advance from a line of credit. For instance, with reference to an example that can be described in the context of FIG. 2, analysis module 296 determines that reseller 121 has requested an advance. Analysis module 296 outputs to notification module 294 information about the advance. Notification module 294 causes communication unit 285 to output a signal over network 105. Lender mobile device 182 detects a signal over network 105 and determines that the signal includes information sufficient to present a user interface. Lender mobile device 182 generates data associated with a user interface and presents user interface 383A at display 185 of lender mobile device 182 as illustrated in FIG. 3A.

In FIG. 3A, user interface 383A includes a message (i.e., an email) about a requested advance by reseller 121 (i.e., “ABC Reseller”), and includes information about the request, the reseller's balance, and current borrowing base. In some examples, the current borrowing base may have been recently calculated by lender computing system 280, and as such may be a near or seemingly-near real time representation of the borrowing base for ABC Reseller. User interface 383A further prompts the user to approve the request (button 385), defer deciding the request (e.g., allow further time for research or consideration, button 386), or deny the request (button 387).

FIG. 3B illustrates an example user interface that may be presented by a computing device as a result of receiving information about an approval of an advance request. For instance, with reference FIG. 2 and FIG. 3A, lender mobile device 182 detects input that lender mobile device 182 determines corresponds to a selection of button 385 of FIG. 3A. In response, lender mobile device 182 outputs a signal over network 105. Communication unit 285 of lender computing system 280 detects a signal over network 105. Communication unit 285 outputs information about the signal to notification module 294. Notification module 294 determines that the signal corresponds to approval of the advance request. Notification module 294 causes communication unit 285 to output a signal over network 105. Reseller mobile device 122 detects a signal over network 105 and determines that the signal includes information sufficient to present a user interface. Reseller mobile device 122 generates data associated with a user interface and presents user interface 323B at display 125 of reseller mobile device 122 as illustrated in FIG. 3B.

In FIG. 3A, user interface 323B includes a message indicating that lender 181 (i.e., “XYZ Financing”) has approved the request to advance funds. In some examples, user interface 323B may include information underlying the decision to approve the request, including the current balance on the line of credit, the maximum available balance, the current borrowing base, and/or other information.

FIG. 3C illustrates another example user interface that may be presented by a computing device as a result of receiving information about an approval of an advance request. For instance, with reference FIG. 2, analysis module 296 of lender computing system 280 determines that the requested funds have been transferred to a bank account owned by reseller 121. Analysis module 296 outputs to notification module 294 information about the transfer. Notification module 294 causes communication unit 285 to output a signal over network 105. Reseller mobile device 122 detects a signal over network 105 and determines that the signal includes information sufficient to present a user interface. Reseller mobile device 122 generates data associated with a user interface and presents user interface 323C at display 125 of reseller mobile device 122 as illustrated in FIG. 3C. In FIG. 3C, user interface 383C includes a message indicating that the requested funds have been transferred into a bank account owned by reseller 121 (i.e., ABC Reseller).

In some examples, similar procedures might provide ongoing status about the line of credit balance or balances for other accounts, and also might provide suggestions relating to such accounts. For example, notification module 294 might cause a notification to be sent to mobile device 122 when the balance on the line of credit exceeds a certain amount or a certain percentage (e.g., 90%) of maximum. In response, mobile device 122 may present the notification to a user in the form of a user interface similar to the examples illustrated herein.

FIG. 3D illustrates an example user interface that may be presented by a computing device as a result of analyzing information stored within accounting system 260. For instance, with reference to an example that can be described in the context of FIG. 2, analysis module 296 causes communication unit 285 to output a signal over network 105. Communication unit 265 of accounting system 260 detects a signal over network 105 and outputs to accounting module 276 information about the signal. Accounting module 276 determines that the signal corresponds to a request, from an authorized requestor, for information about banking activities of reseller 121. Accounting module 276 causes communication unit 265 to output a signal over network 105. Communication unit 285 of lender computing system 280 detects a signal and outputs to analysis module 296 information about the signal. Analysis module 296 determines that the signal includes information about the banking activities of reseller 121. Analysis module 296 further determines, based on the information about the banking activities, that reseller 121 has significant foreign account debtors. Analysis module 296 further determines that businesses with significant foreign account debtors are good candidates for foreign exchange services that lender 181 may offer. In response, analysis module 296 causes communication unit 285 to output a signal over network 105. Lender mobile device 182 detects a signal over network 105 and determines that the signal includes information sufficient to present a user interface. Lender mobile device 182 generates data associated with a user interface and presents user interface 383D at display 185 of lender mobile device 182 as illustrated in FIG. 3D.

In FIG. 3D, user interface 383D includes a message about a possible cross-selling opportunity available to lender 181 (i.e., XYZ Financing). Lender mobile device 182 may present, in response to detecting selection of button 388, further information about the cross-selling opportunity. Lender mobile device 182 may alternatively present, in response to detecting selection of button 389, a proposed email inquiring about offering foreign exchange services. Further, lender mobile device 182 may dismiss the notification about the opportunity in response to detecting selection of button 390.

In the example illustrated in connection with FIG. 3D, analysis module 296 identified the cross-selling opportunity based on financial information about reseller 121 retrieved from accounting system 260. Lender computing system 180 may have access credentials enabling access to such information, and/or may have access to such information for other purposes (e.g., calculating a current borrowing base). The information available from accounting computing system 160 might be effectively used by analysis module 296 to identify cross-selling and/or upselling opportunities. Notification module 294 may provide nonfictions about such opportunities by, for example, sending a communication to lender mobile device 182.

In general, notification module 294 of lender computing system 280 may send at least two types of notifications and/or messages: (1) notifications about financing status events (sent to both a user of lender mobile device 182 and to a user of reseller mobile device 122) and (2) messages identifying business opportunities in the form of cross-selling and upselling opportunities (sent to a user of lender mobile device 182 or to a device operated by another associated with lender 181). For example, notification module 294 may generate and send various notifications, including information about the status of financing requests, approvals, borrowing base calculations, and line of credit usage. The frequency of and type of those notifications could be initially configured by the user of lender mobile device 182 (e.g., a relationship manager employed by lender 181) and by a user of reseller mobile device 122 (e.g., an employee of reseller 121). Thereafter, notification module 294 may learn which items the recipient wants to continue receiving, based on how the recipient interacts with messages of different types. For example, if messages are not often read, or are deleted, notifications of a similar type might not be sent in the future. On the other hand, messages that the recipient tends to act on, could be given a higher priority, and perhaps flagged in some way to ensure the recipient sees those messages.

Notification module 294 may generate and send notifications and/or messages about cross-selling opportunities based on its access to the reseller's financial information at accounting computing system 160. For example, notification module 294 and/or analysis module 296 may identify, based on the financial information, bank service fees charged by competing banks, and determine situations where lender 181 is able to offer a competitive service to reduce such fees. Notification module 294 may send a message to a device operated by a relationship manager employed by lender 181. The message may identify the opportunity to sell the identified competitive service. In another example, notification module 294 and/or analysis module 296 might identify situations in which reseller 121 has foreign subsidiaries, and might therefore generate a message intended for the relationship manager at lender 181 describing how foreign exchange services could beneficial to that reseller. In another example, notification module 294 and/or analysis module 296 might identify situations in which a reseller has a significant term loan, and may generate a message describing how interest rate hedging services could be helpful to that reseller.

Further, notification module 294 may generate and send notifications and/or messages about upselling opportunities based on its access to the reseller's financial information at accounting computing system 160. For instance, notification module 294 and/or analysis module 296 may identify, based on the financial information, situations where reseller 121 is working with a vendor (e.g., another vendor 111) that has a reseller financing program being sponsored by lender 181, and where that reseller is not participating in that other vendor's program. Notification module 294 may cause a message to be sent to the relationship manager at lender 181 identifying the opportunity to offer to reseller 121 participation in the program. In another example, notification module 294 and/or analysis module 296 may, based on analysis of the reseller's financial data, identify instances where lender 181 is missing out on potential business, such as where a reseller bought inventory from a vendor on “open account” (meaning through a direct purchase from the vendor, without a financing partner such as lender 181). Analysis of the reseller's financial data, enabled through availability of financial information at accounting computing system 160, provides visibility into such missed potential business, and the system could send messages to a manager employed by lender 181 that highlight new opportunities based on information determined about previously missed business opportunities.

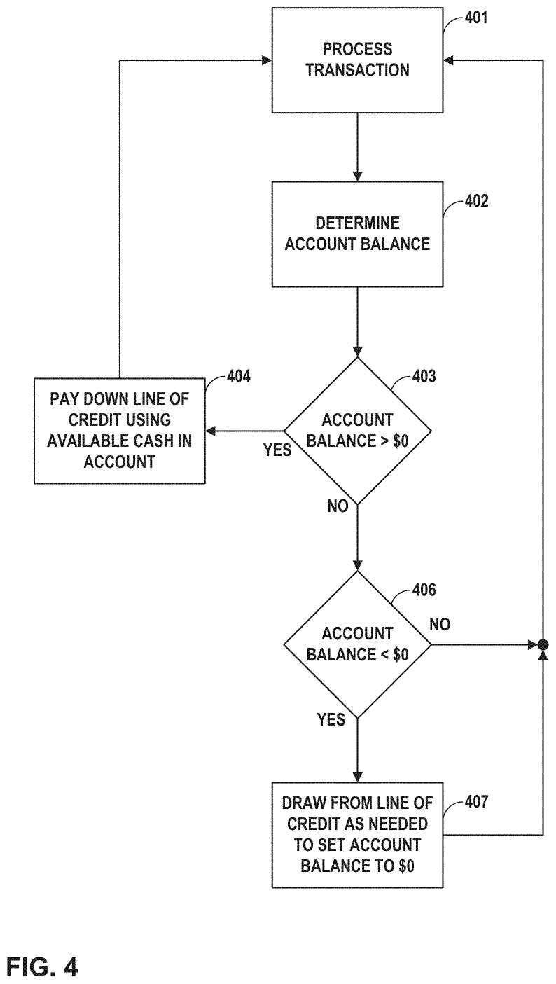

FIG. 4 is a flow diagram illustrating accounting operations performed by an example computing system lender computing system in accordance with one or more aspects of the present disclosure. FIG. 4 illustrates operations corresponding to what might be referred to as “zero balance accounting.” Such accounting practices may be used systems described herein, such as system 100 of FIG. 1 and system 200 of FIG. 2.

FIG. 4 is described below within the context of lender computing system 180 of FIG. 1. In other examples, operations described in FIG. 4 may be performed by one or more other components, modules, systems, or devices. Further, in other examples, operations described in connection with FIG. 4 may be merged, performed in a difference sequence, or omitted.

In the example of FIG. 4, reseller 121 is assumed to have at least two accounts, a cash bank account, and a line of credit extended to reseller 121 by lender 181. During the course of business operations, when cash is needed by reseller 121, cash is drawn from the line of credit. When cash is available in the bank account, that cash is used to pay down the line of credit. In some examples, once the line of credit has been paid off (i.e., the line of credit has no outstanding balance), any excess cash in the bank account held by reseller 121 might be invested in a treasury or other account. The result is that the line of credit is used in an efficient manner, and any excess cash can be invested productively.

If lender computing system 180 has access to current financial information for reseller 121, lender computing system 180 may be able to determine an accurate and current borrowing base for reseller 121. And therefore, lender computing system 180 may be able to make an accurate determination of a maximum line of credit that lender 181 may be willing to extend to reseller 121 at any given time. With that information, lender computing system 180 can effectively implement zero balance accounting, and may do so automatically. FIG. 4 is described below within the context of lender computing system 180 of FIG. 1. Systems described herein may advantageously practice one or more aspects of the process illustrated in FIG. 4. In other examples, operations described in FIG. 4 may be performed by one or more other components, modules, systems, or devices. Further, in other examples, operations described in connection with FIG. 4 may be merged, performed in a difference sequence, or omitted.

In the example of FIG. 4, and in accordance with one or more aspects of the present disclosure, banking computing system 190 and/or lender computing system 180 may process one or more transactions during the normal course of business operations (401). Such transactions may affect (e.g., increase or decrease) the balance associated with a cash account held by reseller 121. Lender computing system 180 may determine a cash account balance held by reseller 121 (402). For instance, in the example of FIG. 2, lender computing system 180 requests, from banking computing system 190 over network 105, information about the balance in the bank account held by reseller 121. Banking computing system 190 responds with information about the balance.

Lender computing system 180 may determine that the cash account balance is greater than zero (403). Lender computing system 180 evaluates the information about the balance, and if lender computing system 180 determines that the balance is greater than zero, lender computing system 180 may use the available cash to pay down any balance on the line of credit held by reseller 121 (404). To do so, lender computing system 180 may request, from banking computing system 190 over network 105, information about the balance on the line of credit. Lender computing system 180 may receive information about the line of credit and cause banking computing system 190 to use the excess cash to pay down the line of credit using any available cash, until the balance on the line of credit is zero.

Lender computing system 180 may determine that the cash account balance is less than zero (405). If lender computing system 180 determines that the balance on the bank account held by reseller 121 is less than zero, lender computing system 180 may draw from the line of credit as needed unit the cash account balance is restored to zero (406). For instance, lender computing system 180 may cause banking computing system 190 to transfer funds from the line of credit held by reseller 121 until the cash account balance for reseller 121 has been restored to zero (407).

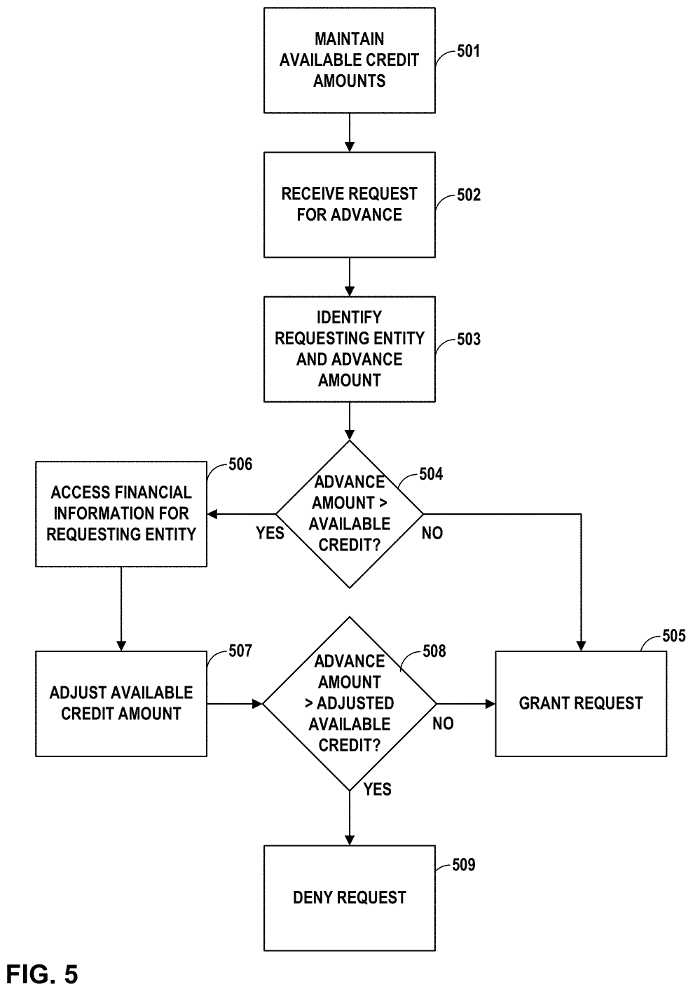

FIG. 5 is a flow diagram illustrating operations performed by an example computing system lender computing system in accordance with one or more aspects of the present disclosure. FIG. 5 is described below within the context of lender computing system 180 of FIG. 2. In other examples, operations described in FIG. 5 may be performed by one or more other components, modules, systems, or devices. Further, in other examples, operations described in connection with FIG. 5 may be merged, performed in a difference sequence, or omitted.

In the example of FIG. 5, and in accordance with one or more aspects of the present disclosure, lender computing system 180 may maintain available credit amounts for one or more resellers 121 (501). For instance, in some examples, lender 181 may extend lines of credit to one or more resellers 121. For each reseller 121, lender computing system 180 may maintain an available credit amount, based on previous cash advances extended to each of reseller 121 and based on payments received from each reseller 121. Lender computing system 180 may also maintain other information about each of resellers 121, such as access credentials enabling lender computing system 180 to access financial information about each of resellers 121. Such financial information may be up-to-date or near-real time financial information, and may include information sufficient to determine a borrowing base for each of resellers 121.

Lender computing system 180 may receive a request for an advance (502). For instance, lender computing system 180 may receive, over network 105, a signal that it determines corresponds to a request to advance cash. Lender computing system 180 may identify the requesting entity and the advance amount (503). Lender computing system 180 determine, based on the signal received over network 105, which of the resellers 121 originated the request to advance cash. Lender computing system 180 may further determine, based on the signal received, an advance amount, which may be an amount of cash that the requesting reseller 121 seeks to have advanced.

Lender computing system 180 may determine whether the advance amount is greater than the available credit for the requesting entity (504). In some examples, lender computing system 180 may grant the request if the advance amount is less than the available credit (505). If the request amount is greater than the available credit, then lender computing system 180 may access financial information for the requesting entity (506). For instance, lender computing system 180 may request, over network 105, financial information about reseller 121 that reseller 121 maintains at accounting computing system 160. Accounting computing system 160 may respond to the request by sending, over network 105, financial information about reseller 121. Lender computing system 180 may receive, over network 105, the financial information from accounting computing system 160.

Lender computing system 180 may adjust the available credit (507). Lender computing system 180 may perform a borrowing base calculation taking into account current financial information about reseller 121. Lender computing system 180 may determine a borrowing base for reseller 121 based on recent accounts receivables for reseller 121, aging information associated with those accounts receivables, any offsetting accounts payables, and other information.

Lender computing system 180 may grant the request if the advance amount is not greater than the adjusted available credit (508). For instance, lender computing system 180 may determine that the borrowing base has increased for reseller 121, and that the advance amount is not greater than the adjusted available credit (505). Lender computing system 180 deny the request if the advance amount is greater than the adjusted available credit (509). In some examples, lender computing system 180 may offer to advance a lesser amount, rather than denying the request. Such a lesser amount may, in some examples, be an amount equal to or approximately equal to the remaining adjusted available credit for reseller 121.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The detailed description set forth above is intended as a description of various configurations and is not intended to represent the only configurations in which the concepts described herein may be practiced. The detailed description includes specific details for the purpose of providing a thorough understanding of the various concepts. However, these concepts may be practiced without these specific details. In some instances, well-known structures and components are shown in block diagram form in the referenced figures in order to avoid obscuring such concepts.

In accordance with one or more aspects of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

1. A method comprising:
maintaining, by a computing system, access credentials for each of a plurality of entities;
receiving, by the computing system and over a network, an advance request;
identifying, by the computing system and based on the advance request, a requesting entity associated with the advance request and an advance amount associated with the advance request, wherein the requesting entity is one of the plurality of entities;
accessing, by the computing system and over the network using the access credentials for the requesting entity, financial information maintained by the requesting entity at an accounting system, wherein the financial information includes accounts receivable information associated with the requesting entity and aging information associated with the accounts receivable information;
accessing, by the computing system and over the network using the access credentials for the requesting entity, supply chain relationship information identifying a plurality of vendors for which the requesting entity resells products in a supply chain, wherein accessing the supply chain relationship information includes querying, over the network, the accounting system for information about transactions performed by the requesting entity including identities of participants in the transactions;
determining, by the computing system and based on the financial information, a borrowing base for the requesting entity;
determining, by the computing system and based on the borrowing base and the advance amount, a status for the advance request;
sending, by the computing system and over the network to a computing device operated by the requesting entity, information about the status for the advance request;
identifying, by the computing system and based on an analysis of the accessed information about transactions performed by the requesting entity including identities of participants in the transactions, a direct purchase vendor that supplies products to the requesting entity through direct purchases by the requesting entity from the direct purchase vendor;
outputting, by the computing system and over the network to a device operated by a user, information sufficient to present a user interface at the device operated by the user, wherein the user interface presents, without requiring the user to have prior knowledge of the direct purchase vendor, cross-selling information that identifies the requesting entity, provides information about transactions performed by the requesting entity, and prompts the user to choose whether to offer to provide services for financing future product purchases made by the requesting entity from the direct purchase vendor;
generating, by the computing system and responsive to interactions with the user interface, a proposed communication to the requesting entity offering to provide services for financing future product purchases made by the requesting entity from the direct purchase vendor;
detecting, by the computing system and over the network from the device operated by the user, an indication of input choosing to offer to provide services for financing future product purchases made by the requesting entity from the direct purchase vendor; and
responsive to detecting input choosing to offer to provide services for financing future product purchases made by the requesting entity from the direct purchase vendor, outputting over the network the proposed communication to the computing device operated by the requesting entity.

2. The method of claim 1, wherein the financial information further includes accounts payable information, and wherein determining a borrowing base includes:
increasing the borrowing base based on a first accounts receivable included within the financial information;
disregarding, based on the aging information, a second accounts receivable included within the financial information; and
decreasing the borrowing base based on the accounts payable information.

3. The method of claim 1, wherein determining the status for the advance request includes:
determining that the advance amount does not exceed an available credit amount for the requesting entity, where the available credit amount is based on the borrowing base;
sending, over the network, information about the advance amount and the available credit amount; and
receiving, over the network, an indication that the advance request was approved.

4. The method of claim 1, wherein sending information about the status for the advance request includes:
sending, to a computing device controlled by the requesting entity, a message indicating that the advance request was approved; and
sending, to the computing device controlled by the requesting entity, a message indicating that funds have been transferred.

5. The method of claim 1, wherein sending information about the status for the advance request includes:
sending, to a computing device controlled by the requesting entity, a message offering to approve the advance request, but for an amount that is lower than the advance amount.

6. The method of claim 1, wherein the financial information further includes information about banking transactions for the requesting entity, the method further comprising:
identifying, by the computing system and based on the financial information, an opportunity to provide further services to the requesting entity; and
communicating, by the computing system and over the network, information about the opportunity to provide further services to the requesting entity.

7. The method of claim 6, wherein the opportunity to provide further services involves providing at least one of:
banking services, foreign exchange services, interest rate hedging services, and supply chain financing services.

8. A computing system comprising:
a storage device; and
processing circuitry having access to the storage device and configured to:
store access credentials for each of a plurality of entities,
receive, over a network, an advance request,
identify, based on the advance request, a requesting entity associated with the advance request and an advance amount associated with the advance request, wherein the requesting entity is one of the plurality of entities,
access, over the network using the access credentials for the requesting entity, financial information maintained by the requesting entity at an accounting system, wherein the financial information includes accounts receivable information associated with the requesting entity and aging information associated with the accounts receivable information,
access, over the network using the access credentials for the requesting entity, supply chain relationship information identifying a plurality of vendors for which the requesting entity resells products in a supply chain, wherein accessing the supply chain relationship information includes querying, over the network, the accounting system for information about transactions performed by the requesting entity including identities of participants in the transactions,
determine, based on the financial information, a borrowing base for the requesting entity,
determine, based on the borrowing base and the advance amount, a status for the advance request,
send, over the network to a computing device operated by the requesting entity, information about the status for the advance request;
identify, based on an analysis of the accessed information about transactions performed by the requesting entity including identities of participants in the transactions, a direct purchase vendor that supplies products to the requesting entity through direct purchases by the requesting entity from the direct purchase vendor,
output, over the network to a device operated by a user, information sufficient to present a user interface at the device operated by the user, wherein the user interface presents, without requiring the user to have prior knowledge of the direct purchase vendor, cross-selling information that identifies the requesting entity, provides information about transactions performed by the requesting entity, and prompts the user to choose whether to offer to provide services for financing future product purchases made by the requesting entity from the direct purchase vendor,
generating, by the computing system and responsive to interactions with the user interface, a proposed communication to the requesting entity offering to provide services for financing future product purchases made by the requesting entity from the direct purchase vendor;
detect, over the network from the device operated by the user, an indication of input choosing to offer to provide services for financing future product purchases made by the requesting entity from the direct purchase vendor, and
responsive to detecting input choosing to offer to provide services for financing future product purchases made by the requesting entity from the direct purchase vendor, output over the network the proposed communication to the computing device operated by the requesting entity.

9. The computing system of claim 8, wherein the financial information further includes accounts payable information, and wherein to determine a borrowing base, the processing circuitry is further configured to:
increase the borrowing base based on a first accounts receivable included within the financial information;
disregard, based on the aging information, a second accounts receivable included within the financial information; and
decrease the borrowing base based on the accounts payable information.

10. The computing system of claim 8, wherein to determine the status for the advance request, the processing circuitry is further configured to:
determine that the advance amount does not exceed an available credit amount for the requesting entity, where the available credit amount is based on the borrowing base;
send, over the network, information about the advance amount and the available credit amount; and
receive, over the network, an indication that the advance request was approved.

11. The computing system of claim 8, wherein to send information about the status for the advance request, the processing circuitry is further configured to:
send, to a computing device controlled by the requesting entity, a message indicating that the advance request was approved; and
send, to the computing device controlled by the requesting entity, a message indicating that funds have been transferred.

12. The computing system of claim 8, wherein to send information about the status for the advance request, the processing circuitry is further configured to:
send, to a computing device controlled by the requesting entity, a message offering to approve the advance request, but for an amount that is lower than the advance amount.

13. The computing system of claim 8, wherein the financial information further includes information about banking transactions for the requesting entity, and wherein the processing circuitry is further configured to:
identify, based on the financial information, an opportunity to provide further services to the requesting entity; and
communicate, over the network, information about the opportunity to provide further services to the requesting entity.

14. The computing system of claim 13, wherein the opportunity to provide further services involves providing at least one of:
banking services, foreign exchange services, interest rate hedging services, and supply chain financing services.

15. A computer-readable storage medium comprising instructions that, when executed, configure processing circuitry of a computing system to:
store access credentials for each of a plurality of entities;
receive, over a network, an advance request;
identify, based on the advance request, a requesting entity associated with the advance request and an advance amount associated with the advance request, wherein the requesting entity is one of the plurality of entities;
access, over the network using the access credentials for the requesting entity, financial information maintained by the requesting entity at an accounting system, wherein the financial information includes accounts receivable information associated with the requesting entity and aging information associated with the accounts receivable information;
access, over the network using the access credentials for the requesting entity, supply chain relationship information identifying a plurality of vendors for which the requesting entity resells products in a supply chain, wherein accessing the supply chain relationship information includes querying, over the network, the accounting system for information about transactions performed by the requesting entity including identities of participants in the transactions;
determine, based on the financial information, a borrowing base for the requesting entity;
determine, based on the borrowing base and the advance amount, a status for the advance request;
send, over the network to a computing device operated by the requesting entity, information about the status for the advance request;
identify, based on an analysis of the accessed information about transactions performed by the requesting entity including identities of participants in the transactions, a direct purchase vendor that supplies products to the requesting entity through direct purchases by the requesting entity from the direct purchase vendor,
output, over the network by a device operated by a user, information sufficient to present a user interface at the device operated by the user, wherein the user interface presents, without requiring the user to have prior knowledge of the direct purchase vendor, cross-selling information that identifies the requesting entity, provides information about transactions performed by the requesting entity, and prompts the user to choose whether to offer to provide services for financing future product purchases made by the requesting entity from the direct purchase vendor,
generating, by the computing system and responsive to interactions with the user interface, a proposed communication to the requesting entity offering to provide services for financing future product purchases made by the requesting entity from the direct purchase vendor;
detect, over the network from the device operated by the user, an indication of input choosing to offer to provide services for financing future product purchases made by the requesting entity from the direct purchase vendor, and
responsive to detecting input choosing to offer to provide services for financing future product purchases made by the requesting entity from the direct purchase vendor, output over the network the proposed communication to the computing device operated by the requesting entity.

16. The computer-readable storage medium of claim 15, wherein the financial information further includes accounts payable information, and wherein the instructions that configure the processing circuitry to determine a borrowing base include instructions that, when executed, configure the processing circuitry to:
increase the borrowing base based on a first accounts receivable included within the financial information;
disregard, based on the aging information, a second accounts receivable included within the financial information; and
decrease the borrowing base based on the accounts payable information.

17. The computer-readable storage medium of claim 15, wherein the instructions that configure the processing circuitry to determine the status for the advance request include instructions that, when executed, configure the processing circuitry to:
determine that the advance amount does not exceed an available credit amount for the requesting entity, where the available credit amount is based on the borrowing base;
send, over the network, information about the advance amount and the available credit amount; and
receive, over the network, an indication that the advance request was approved.

18. The computer-readable storage medium of claim 15, wherein the instructions that configure the processing circuitry to send information about the status for the advance request include instructions that, when executed, configure the processing circuitry to:
send, to a computing device controlled by the requesting entity, a message indicating that the advance request was approved; and
send, to the computing device controlled by the requesting entity, a message indicating that funds have been transferred.

19. The computer-readable storage medium of claim 15, wherein the instructions that configure the processing circuitry to send information about the status for the advance request include instructions that, when executed, configure the processing circuitry to:
send, to a computing device controlled by the requesting entity, a message offering to approve the advance request, but for an amount that is lower than the advance amount.

20. The computer-readable storage medium of claim 15, wherein the financial information further includes information about banking transactions for the requesting entity, and wherein the instructions, when executed, further configure the processing circuitry to:
identify, based on the financial information, an opportunity to provide further services to the requesting entity; and
communicate, over the network, information about the opportunity to provide further services to the requesting entity.
